(19) United States
(12) Patent Application Publication
(10) Pub. No.: US 2002/0000323 A1
(43) Pub. Date: Jan. 3, 2002

(54) CULTIVATOR RING AND APPARATUS

(76) Inventor: KEVIN G. MCDONALD, SALIDA, CA (US)

Correspondence Address: JOHN WERESH, SHOOK HARDY & BACON, ONE KANSAS CITY PLACE, 1200 MAIN STREET, KANSAS CITY, MO, 641052118

(21) Appl. No.: 09/201,938

(22) Filed: Dec. 1, 1998

Related U.S. Application Data
(63) Continuation-in-part of application No. 08/798,565, filed on Feb. 11, 1997, now abandoned.

(51) Int. Cl. A01B 21/02

(52) U.S. Cl. 172/537; 172/540

(57) ABSTRACT

A cultivator apparatus includes a frame, a tube supported on the frame, and a plurality of cultivator rings loosely placed over the axis of said tube. The cultivator rings each include a tubular base including cylindrical interior and exterior circumferential surfaces, and a planer, ring-shaped blade presenting a circular interior circumferential edge and an opposed exterior circumferential edge. The interior edge of each blade is of a diameter slightly larger than the diameter of the exterior surface of the respective base, and each blade is welded to the exterior surface of the respective base along the interior edge. A method of constructing the rings is also provided.

### CROSS-REFERENCE TO RELATED APPLICATIONS

The present application is a continuation-in-part of U.S. Ser. No. 08/798,565, filed Feb. 11, 1997, by Kevin McDonald, and entitled CULTIVATOR.

### BACKGROUND OF THE INVENTION

This invention relates to a crop cultivator. More particularly, the invention relates to an enhanced profile cultivator ring for use with a ring-type cultivator.

Agricultural ring-type cultivators are utilized for a variety of field cultivation tasks including tilling, packing in seeds, sealing in fertilizers and fumigants, breaking clods and crusts in fields, and pulverizing crusted soil. They are typically constructed as a tube or pipe mounted in a frame. A plurality of rings loosely mounted around the tube are used to perform the cultivation tasks. The tube and frame are configured such that the axis of the tube is transverse to the travel of the cultivator when in use. The frame is typically configured so as to constrain each end of the tube at the axis of the tube and to form a yoke for attachment to a tractor or the like for pulling the cultivator over the area to be worked. Existing cultivators may utilize multiple tubes, various configurations of folding attachments, road wheels and hydraulics for moving the cultivator from field to field and similar devices, however, the basic configuration of a tube and frame is common to the various cultivators.

The rings for contacting the soil to perform the cultivation tasks are loosely mounted around the tube and along the axis thereof The rings are placed side-by-side and sufficiently close that they are constrained so that the plane of the ring is held generally in a vertical orientation and the periphery of the rings are oriented to roll along the field when the cultivator is in use. The interior diameter of the ring typically is one to six inches larger than the outer diameter of the tube. This allows the ring to rotate around the tube as the tube is pulled across the field to be cultivated. Further, the difference between the outer diameter of the tube and the inner diameter of each ring allows that the rings may droop or flex below the tube and, thus, follow the contour of the soil.

The peripheries of the rings are the portions of the cultivator which contact the soil and perform the cultivation task. Prior art rings are constructed with a series of spikes around the periphery of the ring to perform the cultivation tasks. These spikes act to contact and penetrate the soil as the cultivator passes over the field. The spikes are affixed to the outside of the cultivator ring in a generally radial direction, and may be tipped slightly in a tangential direction in the plane of the ring. The spikes are typically one-half inch to two inches long with an elongated cone or tooth shape and a blunted end. The teeth are spaced nominally two to four inches apart around the circumference of the ring. Prior art rings are typically two to three inches wide in an axial direction of the tube so that, as mounted on the tube, the spacing between the teeth on adjacent rings is two to three inches.

Existing cultivator ring tooth configurations produce high rolling resistance as the teeth penetrate and embed in the soil when the cultivator passes through the field, increasing the power necessary to pull the cultivator. The length of the teeth on the rings in the prior art configuration is limited, which in turn limits the depth to which prior art cultivators may penetrate the soil to cut through and break up clods and hardpan below the surface of the field. Related to this, it is important that the weight distribution of the penetrating surface of the ring facilitate penetration into the soil. It is desirable for cultivators to push crop stubble and debris below the surface of the field or to lift it and the soil for mixing to facilitate faster breakdown of the plant matter. The spiked configuration has a tendency to only partially push stubble below the surface of the field and its ability to lift soil is limited by the length and configuration of the spikes. Ring breakage due to various stresses placed upon rings in use requires maintenance and creates down-time for ring replacement and, therefore, enhanced ring strength and durability is desirable.

### BRIEF SUMMARY OF THE INVENTION

It is an object of the present invention is to provide a cultivator ring configured to provide less pulling resistance than prior art cultivator rings.

Another object of the invention is to provide a cultivator ring with enhanced down force or penetration relative to conventional rings to facilitate cutting through clods and hardpan below the surface of the field. In addition, it is an object to provide such a ring that has good soil lifting action for churning the soil and covering crop residue.

A further object of the invention is to provide a ring configuration of enhanced strength and durability to minimize ring breakage.

In accordance with these and other objects evident from the following description of a preferred embodiment of the invention, a cultivator apparatus is provided with includes a frame, a tube supported on the frame, and a plurality of cultivator rings loosely placed over the axis of said tube. The cultivator rings each include a tubular base presenting cylindrical interior and exterior circumferential surfaces, and a planer, ring-shaped blade having a circular interior circumferential edge and an opposed exterior circumferential edge. The interior edge of each blade is of a diameter slightly larger than the diameter of the exterior surface of the respective base, and each blade is welded to the exterior surface of the respective base along the interior edge.

By providing a construction in accordance with the present invention, numerous advantages are realized. For example, by employing a tubular base and a planer blade, it is possible to form the rings out of readily available stock material, reducing the cost of manufacture of the rings. In addition, by welding planer blades to a tubular base, the strength of the rings compares favorably to conventional cast rings, and provides enhanced strength and durability, minimizing ring breakage.

In addition, by providing the blades of the rings with circumferential edges that are star-shaped, presenting an aggressive attack angle to the ground, the rings provide enhanced down force relative to conventional cultivator rings and improve lifting and mixing of the soil with crop debris. As such, it is possible to reduce the number of passes that must be made through the field with cultivating equipment in order to prepare the field for a subsequent planting. Further, deep tillage points may be mounted on the cultivator to improve the deep tillage capabilities of the implement, again reducing the number of passes through the field that are required to prepare it for planting.

### BRIEF DESCRIPTION OF THE SEVERAL VIEWS OF THE DRAWING

The preferred embodiment of the present invention is described in detail below with reference to the attached drawing figures, wherein:

FIG. 1 is a perspective view of a ring-type cultivator upon which are mounted cultivator rings constructed in accordance with a first embodiment of the present invention;

FIG. 2 is a partial front elevational view of a cultivator showing a plurality of cultivator rings of the first embodiment;

FIG. 3 is an enlarged front elevational view of a cultivator ring constructed in accordance with the first embodiment, partially cut away to illustrate a base and a blade forming a part thereof;

FIG. 4 is a vertical cross-sectional view taken along line 4-4 of FIG. 2, illustrating the manner in which the cultivator rings are supported on the cultivator;

FIG. 5 is a perspective view of a ring-type cultivator upon which are mounted cultivator rings constructed in accordance with a second embodiment of the present invention;

FIG. 6 is a fragmentary side elevational view of the cultivator shown in FIG. 5;

FIG. 7 is a fragmentary side sectional view of the cultivator shown in FIG. 5, illustrating the manner in which the cultivator rings are supported on the cultivator;

FIG. 8 is a fragmentary rear end elevational view of the cultivator shown in FIG. 5, illustrating a plurality of cultivator rings arranged on the cultivator; and

FIG. 9 is a fragmentary side elevational view of an earth penetrating point of the blade, shown in FIG. 5.

### DETAILED DESCRIPTION OF THE INVENTION

Referring initially to FIG. 4, a cultivator ring constructed in accordance with a first embodiment of the present invention is designated generally by the numeral 10. Cultivator ring 10 comprises a hollow cylindrical-shaped base 12 to the exterior of which is affixed an annular-shaped blade 14. The exterior edge of the blade 14 has a plurality of notches designated by the numeral 16.

Referring now to FIGS. 2 and 4, the cultivator ring 10 in use mounts loosely over a tube 18. As can best be seen in FIG. 4, the interior dimension of the base 12 of the cultivator ring 10 is appreciably larger than the exterior dimension of the tube 18, a dimension which is commonly referred to as flex and is designated by the letter A in FIG. 4.

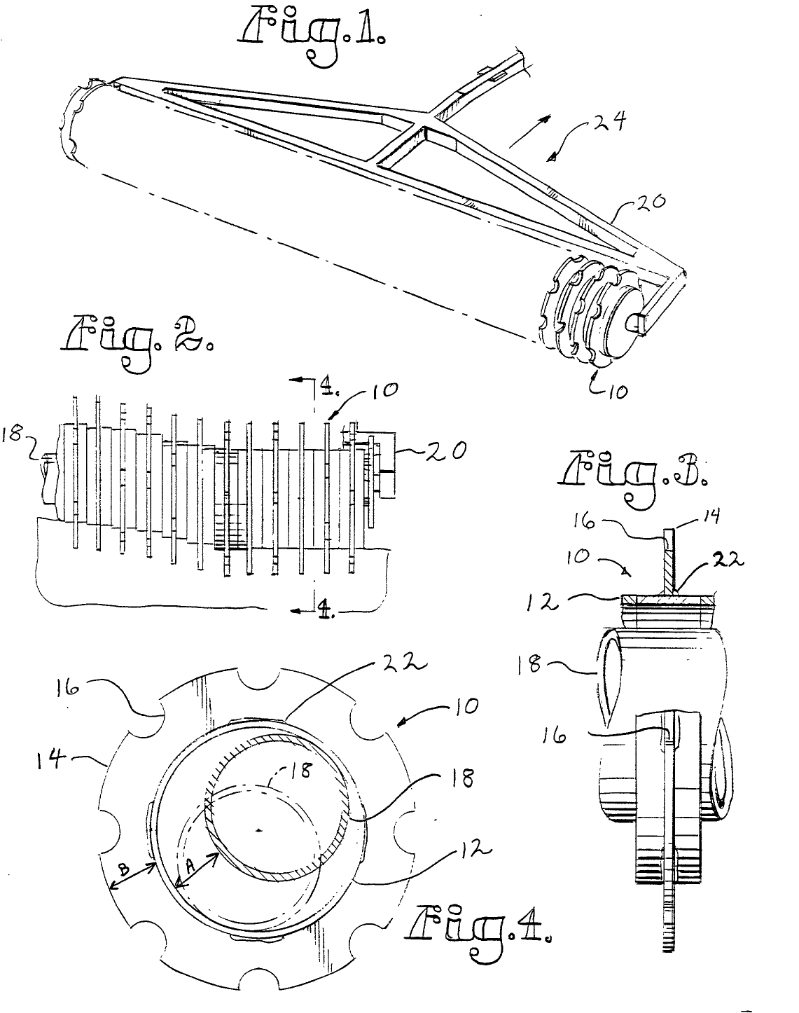

Turning now to FIGS. 1 and 2, the tube 18 is mounted in a frame 20 and affixed in that frame. The particular shape of the frame 20 or manner and attachment of the frame 20 to the tube 18 is not critical. Various configurations of tubes and frames are suitable for use with the cultivator rings 10 of the present invention. The cultivator rings 10, tube 18, and frame 20 form a cultivator 24.

The base 12 of cultivator ring 10 preferably has an interior diameter from about eight inches to about eighteen inches and a width along the axis of the cylinder of from about ¼ inches to about five inches. More preferably, ring 10's inner diameter is from about ten to about sixteen inches and a width of from about three to about five inches. The thickness of the base 12, i.e., the difference between the interior diameter and the exterior diameter, is preferably about ⅜ to ½ of an inch, although it would be obvious to one skilled in the art that a greater or lesser dimension would be suitable if consistent with the strength characteristics required to maintain the shape of the cultivator ring in use. The base 14 may be manufactured from plate steel which is rolled into a hollow cylindrical shape and welded or preferably may be made from sections of pipe which is commercially available and sliced perpendicular to the axis thereof in order to produce the short cylindrical shapes required.

The blade 14 of the cultivator ring 10 is an annular-shaped segment preferably fabricated from ⅜ inch flat plate. The interior diameter of the blade preferably is sized to fit over the applicable base 12 with sufficient gap between the inner diameter of the blade 14 and exterior diameter of the base 12 to allow for irregularities in the two dimensions and provide for a snug fit between the blade 14 and the base 12. Typically, this gap will be 5 to 10 thousandths of an inch to allow ease of assembly of the base 12 and blade 14. Preferably, the blade 14 is affixed to the base 12 by means of welding or the like, designated by the number 22 in FIGS. 3 and 4. Preferably, the weld 22 is applied as a fillet weld to both sides of the blade 14 and applied in a skip fashion so as to allow some flex between the blade 14 and the base 12. The weld may also be applied in a continuous fashion around the entire periphery of the junction of the blade 14 and base 12. As seen in FIG. 3, the blade 14 is preferably affixed to the center of the base 12 equidistant between the ends of the cylinder forming the base 12 so as to minimize twisting of the cultivator ring 10 in use.

The radial thickness of blade 14, shown as dimension B in FIG. 4, preferably is from about two to about eight inches and, more preferably, from about two and one half to about eight inches. As best seen in FIG. 4, blade 14 has a plurality of notches 16 which are generally semicircular in shape and evenly spaced around the outer edge of the blade 14. Preferably, the notches are spaced at nominally 45 degrees apart around the circumference of the blade 14, although spacing from about 30 to about 60 degrees apart is acceptable depending upon the particular type of application which is desired for the blade. The notches 16 applied to blade 14 are preferably formed as semicircular notches with a radius of from about one to about four inches, more preferably, from about one and one quarter to about two and one half inches. As will be obvious to one skilled in the art, a variety of other shapes of notches are suitable to application in the present invention.

In use, a plurality of cultivator rings 10 are loosely fit over a tube 18 which is operably affixed in a frame 20. As the frame 20 is pulled by a tractor or the like (not shown) over a field of ground for cultivation, the blades 14 engage the soil of the field. FIG. 2 shows a portion of a cultivator 24 in contact with the irregular surface of a field. As is shown in FIGS. 2 and 4, the cultivator rings “float” on the inner tube 18 so as to allow the individual cultivator rings to engage the soil at various heights across the width of the cultivator 24.

The cultivator ring 10 of the present invention provides for several advantages over the standard prior art rings. The annular blade shape 14 of the present invention enhances the strength and stability of the ring 10 as compared to a prior art cultivator rings which utilizes pins to penetrate the soil because the blade 14 and base 12 form a “T” shape with inherently rigid characteristics, as best seen in FIG. 3. Thus, the shape of the blade helps provide greater resistance to breakage than presently available rings. Because the cultivator ring 10 is more stable, the blade 14 can be made deeper for greater penetration of the soil to cut through clods and the like above and below the surface of the soil. This allows for more effective pulverization of the soil as the cultivator 24 is pulled over the soil. The deeper blade 14 pushes stubble below the surface of the soil more effectively than pins, in part because the blade 14 edge presents a continuous running surface to the soil as compared to pins which present a discontinuous poking action on a relatively small percentage of the soil. Therefore, the present invention cultivator rings 10 push stubble below the surface more effectively, enhancing rapid breakdown of the stubble.

The notches 16 in the blade 14 help provide a positive surface on which the cultivator ring can bite into the soil, enhancing rotation of the cultivator ring through the soil. The notches 16 also reduce the surface area of the blade 14 against the soil, increasing relative pressure of the blade 14 against the soil for easier penetration. The relatively smooth profile presented by the smooth 20 annular shape of the blade as compared to prior art pins provides less resistance against the blade as the cultivator roller is being pulled through the soil.

The continuous edge presented by the blade 14 of the present invention to the soil allows a wider spacing between blades to be utilized to effectively cover the same amount of soil as compared to a prior art pin device. Wider spacing between the blades 14 further decreases resistance to pulling the cultivator roller through the soil, further increasing the relative pressure of the blade 14 edge against the soil, enhancing penetration.

One skilled in the art would appreciate that various types of materials may be employed for the blades 14 and base 12 of the present invention. The particular material utilized will determine the mass, rigidity, and life of the cultivator ring 10. In most instances, it is preferable to use common plow-grade steel, such as Standard of Automotive Engineers grade 1080 or harder for the blade 14 and standard pipe-grade steel such as grade A36 steel or harder for the base 12, welded together with a compatible welding material. Alternately, a material such as AR400 steel could be used to form the blade and base. As would be obvious to one skilled in the art, various other materials will provide acceptable results.

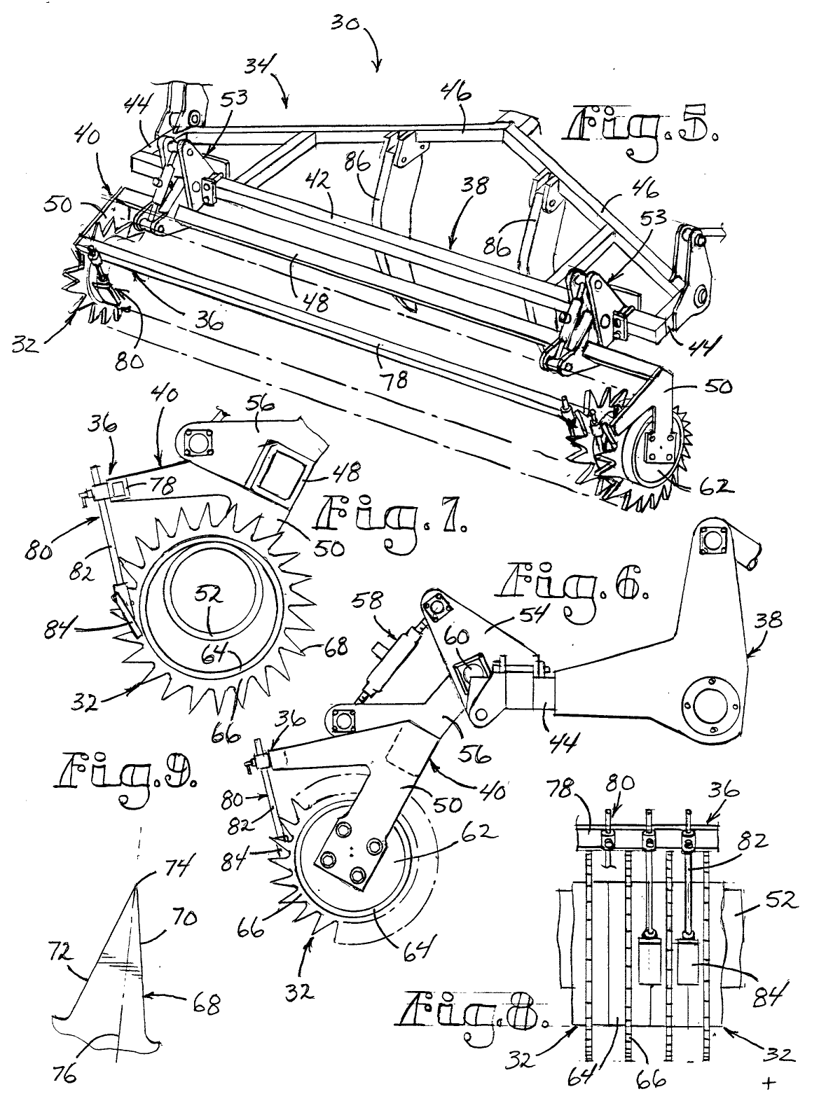

Turning to FIG. 5, a second cultivator 30 is illustrated, wherein a plurality of rings 32 constructed in accordance with a second embodiment of the invention are employed. The cultivator resembles the cultivator 24 shown in FIGS. 1-4, in that it is adapted to be pulled behind any suitable towing implement such as a tractor or the like. However, the cultivator 30 differs from the cultivator 24 in several respects.

The cultivator 30 broadly includes a frame 34, a plurality of the cultivator rings 32 supported on the frame for rotation as the towing vehicle pulls the cultivator through a field, and a cleaning assembly 36 for cleaning the spaces between the rings during cultivation so that debris does not build up between the rings.

The frame 34 includes a front portion 38 that is hitched to the towing vehicle, and a rear portion 40 that is supported by the front portion for pivotal movement between raised and lowered positions. The front portion 38 includes a rear tool bar 42, a pair of laterally disposed side bars 44 connected to the rear tool bar at the ends thereof, and a pair of front bars 46 connected to the side bars and to one another at the front of the frame. A hitch is secured to the front frame portion, and consists of a single-point, three-point, or any other type of hitch desired.

The rear portion 40 of the frame includes a horizontal frame member 48, a pair of laterally disposed side arms 50 connected to the horizontal frame member at the ends thereof, and a tube 52 connected between the side arms and extending in a direction parallel to the horizontal frame member 48. As shown in FIG. 6, the horizontal frame member 48 is supported on the tool bar 42 of the front portion of the frame by a pair of support assemblies 53, each of which includes a support bracket 54 secured to the tool bar, a support arm 56 mounted on the bracket for pivotal movement between raised and lowered positions, and a hydraulic piston and cylinder assembly 58 that is connected between the bracket and support arm for shifting the support arm. Alternately, a threaded adjustment mechanism of conventional construction could be employed between the horizontal frame member 48 and the tool bar 42 to provide the pivotal movement.

As illustrated in FIG. 1, each support bracket 54 includes a pair of laterally spaced bracket elements that are rigidly secured to the tool bar 42 and that present an interior space within which the support arm is received. Returning to FIG. 6, a pin 60 is supported between the bracket elements, and the support arm 56 is received on the pin for pivotal movement between the raised and lowered positions. The support arms 56 are rigidly connected to the horizontal frame member 48 so that the arms pivot together to move the rear frame portion up and down about the pins 60 when the piston and cylinder assemblies 58 are actuated. Preferably, control of the assemblies is achieved by conventional hydraulic circuitry which includes a control valve that may be actuated from the cab or seat of the towing vehicle to extend and retract the pistons of the assemblies, as desired.

The side arms 50 of the rear frame portion are each V-shaped, presenting a pair of arm segments protruding outward from the horizontal frame member. As shown in FIG. 1, the tube 52 is connected between the lower segments of the side arms, and the cleaning assembly 36 is supported between the upper segments. The tube 52 is circular in cross section, as illustrated in FIG. 7, and is preferably formed of a rigid supportive material such as steel or other metal. A pair of end plates 62, shown in FIG. 6, are provided for closing off the ends of the tube and for providing a mounting surface by which the tube is secured to the side arms of the frame by threaded fasteners or the like. As such, the tube does not rotate relative to the frame. The tube 52 includes an outer surface of a predetermined diameter that is substantially smaller than the inner diameter defined by the cultivator.

The cultivator ring 32 constructed in accordance with the second embodiment of the invention each broadly include a base 64 and a blade 66 welded to the base. As shown in FIG. 7, the base 64 of each cultivator ring preferably has an interior diameter from about eight inches to about eighteen inches and, as shown in FIG. 8, includes a width along the axis of the tube of from about two inches to about five inches. More preferably, the ring inner diameter is from about ten to about sixteen inches and the ring includes a width of from about three to about five inches. The radial thickness of the base 64 is preferably about ⅜ to ½ of an inch, although it would be obvious to one skilled in the art that a greater or lesser dimension would be suitable if consistent with the strength characteristics required to maintain the shape of the cultivator ring in use. The base 64 may be manufactured from plate steel which is rolled into a hollow cylindrical shape and welded. Preferably, however, it is made from conventional pipe of a hard steel by cross cutting circular sections of pipe in a plane perpendicular to the longitudinal axis thereof in order to produce the short tubular shapes required.

Returning to FIG. 7, the blade 66 of the cultivator ring is an annular-shaped segment that is preferably fabricated from a flat plate having a thickness of ⅜ inches. An interior hole is cut or punched into the plate, and presents a diameter slightly larger than the outer diameter of the base 64 such that the blade can be positioned on the base during manufacture with a sufficient gap between the inner diameter of the blade and exterior diameter of the base to allow for irregularities in the two dimensions and provide for a snug fit between the blade and the base. Alternately, the blade can be formed by two flat plate sections that are welded together during manufacture. Typically, this gap will be 5 to 10 thousandths of an inch to allow ease of assembly of the base and blade Preferably, the blade 66 is affixed to the base by means of welding or the like, and the weld is applied as a fillet weld to both sides of the blade and in a skip fashion so as to allow some flex between the blade and the base. Alternately, the weld may be applied in a continuous fashion around the entire periphery of the junction of the blade and base. This alternate construction reduces the waste of material relative to a construction in which the blade is formed from a single flat plate of material. As shown in FIG. 8, the blade 66 is preferably affixed to the center of the base equidistant between the axial ends or edges of the cylinder forming the base so as to minimize twisting of the cultivator ring in use.

The radial dimension of the blade 66 preferably is from about two to about eight inches and, more preferably, from about two-and-one-half to about eight inches. In accordance with the second embodiment of the invention, the outer edge of the blade is cut or otherwise shaped to present a plurality of earth-penetrating points 68. As shown in FIG. 9, each point includes a leading edge 70, a trailing edge 72, and a tip 74 that separates the edges from one another. The angle formed between the leading edge of each point and a radial line 76 extending through the tip is smaller than the angle formed between the same radial line and the trailing edge of the point. As such, the leading edges 70 of the points 68 present an aggressive angle of attack that enhances soil penetration relative to conventional cultivator rings, and the trailing edges 72 of the points provide improved lifting of soil as the rings rotate up out of the ground to facilitate mixing of the soil with crop stubble resting on the surface of the ground. The trailing edges 72 of the points also help to drive the ring to reduce the amount of soil that is pushed forward during operation.

Because the cultivator rings 32 of the second embodiment provide increased soil lifting relative to the first embodiment, it is necessary in using the second embodiment to employ the cleaning assembly 36 to prevent soil and debris from getting clogged between adjacent cultivator ring blades. As shown in FIG. 5, the cleaning assembly broadly includes a support bar 78 supported between the side arms 50 of the rear frame portion 40, and a plurality of shoe assemblies 80 depending from the support bar. As shown in FIG. 8, the support bar 78 includes a plurality of laterally spaced support rings that are secured to the bar along the width thereof, each presenting a vertical hole within which one of the shoe assemblies 80 is received. As shown in FIG. 7, each shoe assembly 80 includes an arm 82 received in one of the support rings, and a shoe 84 that is attached to the lower end of the arm. Preferably, a set screw or the like is provided in association with each support ring for securing the respective support arm at a fixed position relative to the underlying cultivator rings, and the set screw permits this position to be adjusted, as desired.

The shoe 84 of each assembly includes a proximal end received on the support arm 82 of the assembly, and a distal end that protrudes downward and inward toward the outer surface of the bases of a pair of laterally adjacent cultivator rings of the apparatus. The shoes are disposed between the blades of adjacent rings 32, and function during rotation of the rings to clean the spaces between the blades to improve penetration of the rings into the soil.

With reference to FIG. 1, the plurality of cultivator rings 32 are loosely fit over the tube 52, and the tube is affixed to the side arms 50 of the rear frame portion 40 in the manner described above to secure the rings on the apparatus. Thereafter, when the rear frame portion of the frame is lowered to the ground and the apparatus is towed across a field to be cultivated, the blades 66 penetrate the soil of the field. As with the rings of the first embodiment, the rings 32 of the second embodiment are allowed to float on the tube so as to allow the individual cultivator rings to engage the soil at various heights across the width of the cultivator, accommodating varying ground heights across the width of the apparatus. However, because of the unique earth-penetrating points 66 on the rings, the blades 66 penetrate the soil, breaking up large clods and stubble, and lifting the soil and stubble for better mixing. In addition, the blades 66 move soil in a way to resettle and level the seed bed, and reduces compaction of the soil.

If desired, the rear portion of the frame may be lifted from engagement with the ground by actuating the piston and cylinder assemblies 58, raising the cultivator rings from the ground on the fly. This type of mounting arrangement is particularly useful where the front portion 38 of the frame is fitted with deep tillage points 86 or other tillage implements that are adapted for use either in combination with the cultivator rings or independently thereof However, the arrangement also facilitates turning of the apparatus between rows and transport of the apparatus between fields.

The cultivator ring of the present invention provides for several advantages over the standard prior art rings. The annular blade shape of the present invention enhances the strength and stability of the ring as compared to a prior art cultivator rings which utilizes pins to penetrate the soil because the blade and base form a “T” shape with inherently rigid characteristics, as best seen in FIG. 8. Thus, the shape of the blade helps provide greater resistance to breakage than presently available rings. Because the cultivator ring is more stable, the blade can be made deeper for greater penetration of the soil to cut through clods and the like above and below the surface of the soil. This allows for more effective pulverization of the soil as the cultivator is pulled over the soil. The deeper blade penetrates the surface of the soil more effectively than the thicker pins of conventional constructions.

One skilled in the art would appreciate that various types of materials may be employed for the blades and base of the present invention. The particular material utilized will determine the mass, rigidity, and life of the cultivator ring In most instances, it is preferable to use common plow-grade steel, such as Standard of Automotive Engineers grade 1080 or harder material, such as AR400 steel, for the blade and standard pipe-grade steel such as grade A36 steel, or harder material, for the base, welded together with a compatible welding material. As would be obvious to one skilled in the art, various other materials will provide acceptable results.

From the foregoing it will be seen that this invention is one well-adapted to attain all the ends and objects set forth above, together with other advantages which are obvious and which are inherent in the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

1. A cultivator ring comprising:
a tubular base including cylindrical interior and exterior circumferential surfaces; and
a planer, ring-shaped blade including a circular interior circumferential edge and an opposed exterior circumferential edge, wherein the interior edge of said blade is of a diameter slightly larger than the diameter of the exterior surface of the base, the blade being welded to the exterior surface of the base along the interior edge.

2. The cultivator ring as recited in claim 1, wherein the base includes a pair of longitudinally spaced marginal edges, and the blade is welded to the exterior surface of the base at a position disposed half the distance between the marginal edges.

3. The cultivator ring as recited in claim 1, wherein the exterior circumferential edge of the blade is star-shaped, presenting a plurality of earth-penetrating points.

4. The cultivator ring as recited in claim 3, wherein each earth-penetrating point includes a leading edge and a trailing edge separated from one another by a tip, the angle formed between the leading edge and a radial line extending through the tip being smaller than the angle formed between the radial line and the trailing edge.

5. A cultivator apparatus comprising:
a frame;
a tube operably connected to said frame; and
a plurality of cultivator rings loosely placed over the axis of said tube, said cultivator rings each including a tubular base including cylindrical interior and exterior circumferential surfaces, and a planer, ring-shaped blade presenting a circular interior circumferential edge and an opposed exterior circumferential edge, wherein the interior edge of each blade is of a diameter slightly larger than the diameter of the exterior surface of the respective base, each blade being welded to the exterior surface of the respective base along the interior edge.

6. A method of constructing a cultivator ring comprising the steps of:
cutting a cross section of a circular tube to form a tubular base including cylindrical interior and exterior circumferential surfaces;
cutting a circular blade from a plate, and forming an interior hole in the blade to form an annular ring-shaped blade including a circular interior circumferential edge and an opposed exterior circumferential edge, wherein the interior edge of said blade is of a diameter slightly larger than the diameter of the exterior surface of the base; and
welding the blade to the exterior surface of the base to form the ring.

7. The method as recited in claim 6, wherein the base includes a pair of longitudinally spaced marginal edges, and the blade is welded to the exterior surface of the base at a position disposed half the distance between the marginal edges.

8. The method as recited in claim 6, wherein the exterior circumferential edge of the blade is cut in a star-shaped pattern presenting a plurality of earth-penetrating points.

9. The method as recited in claim 8, wherein each earth-penetrating point is cut with a leading edge and a trailing edge separated from one another by a tip, the angle formed between the leading edge and a radial line extending through the tip being smaller than the angle formed between the radial line and the trailing edge.
